(19) United States
(12) Patent Application Publication
(10) Pub. No.: US 2013/0321355 A1
(43) Pub. Date: Dec. 5, 2013

(54) WRITING TIP FOR A STYLUS

(71) Applicant: N-trig Ltd., Kfar-Saba (IL)

(72) Inventor: Oren TEIBLUM, Hod-HaSharon (IL)

(21) Appl. No.: 13/905,175

(22) Filed: May 30, 2013

Related U.S. Application Data
(60) Provisional application No. 61/653,434, filed on May 31, 2012.
(60) Provisional application No. 61/775,791, filed on Mar. 11, 2013.

(51) Int. Cl. G06F 3/0354

(52) U.S. Cl. CPC G06F 3/03545
USPC 345/179

(57) ABSTRACT

A stylus includes a housing, a writing tip at least partially extending out of the housing, and circuitry electrically connected to the writing tip, the circuitry operative to providing a signal for transmission via the writing tip. The writing tip of the stylus is formed with a compound material including a non-conductive base material and conductive filler.

### RELATED APPLICATIONS

This application claims the benefit of priority under 35 USC §119(e) of U.S. Provisional Patent Application Nos. 61/653,434 filed May 31, 2012 and 61/775,791 filed Mar. 11, 2013, the contents of which are incorporated herein by reference in their entirety.

### FIELD AND BACKGROUND OF THE INVENTION

The present invention, in some embodiments thereof, relates to a writing tip for a stylus, and more particularly, but not exclusively to a writing tip from which a signal is transmitted for interacting with a digitizer sensor.

Styluses that emit signals are known in the art for use and control of a digitizer. Position detection of the stylus provides input to a computing device associated with the digitizer and is interpreted as user commands. Position detection is performed while the stylus tip is either touching and/or hovering over a detection surface of the digitizer. Some styluses include a pressure sensor sensing pressure applied on a writing tip of the stylus for differentiating between a touch and hover state of the stylus and for sensing the amount of pressure exerted by the stylus during touch. Often, the digitizer is integrated with a display screen and a position of the stylus over the screen is correlated with virtual information portrayed on the screen.

U.S. Pat. No. 7,292,229 entitled “Transparent Digitizer” which is assigned to N-trig Ltd., the contents of which is incorporated herein by reference, describes an electro-magnetic stylus which is triggered to oscillate at a resonant frequency by an excitation coil surrounding a digitizer. The oscillating signal is sensed by the digitizer. The stylus may operate in a number of different states for example hovering, tip touching, right click mouse emulation, and erasing. In some embodiments, the various states are identified by dynamically controlling the resonant frequency of the stylus so that the stylus resonates at a different frequency in each state. A position of the stylus, e.g. the location of the stylus' tip with respect to the digitizer sensor is determined based on signals sensed by the sensor.

U.S. Patent Application Publication No. 2010/0155153 entitled “Digitizer, Stylus and Method of Synchronization Therewith” which is assigned to N-trig Ltd., the contents of which is incorporated herein by reference, describes a method for operating a digitizer with an autonomous asynchronous stylus. Typically the stylus is self-powered, e.g. battery operated stylus that transmits signal bursts at a defined rate. It is described that the signal burst transmitted by the stylus can be modulated to encode identification data for identifying the stylus.

International Patent Application Publication No. WO2012/123951 entitled “Interacting tips for a digitizer stylus” which is assigned to N-trig Ltd., the contents of which is incorporated herein by reference describes a stylus for use with a digitizer sensor that includes a primary tip positioned at the first end of the stylus and associated with a first transmitting element and a secondary tip positioned at a second end of the stylus and associated with a second transmitting element. The first transmitting element is defined to have a smaller diameter than that of the second transmitting element. A transmitting unit transmits a first signal via the first transmitting element with amplitude that is at least twice the amplitude of the second signal transmitted via the second transmitting element. The stylus also includes a powering unit for powering transmission of the first and second signal.

### SUMMARY OF THE INVENTION

According to an aspect of some embodiments of the present invention there is provided a writing tip of a stylus from which a signal can be transmitted. According to some embodiments of the present invention, the writing tip is constructed from a polymer material including a conductive filler and/or additive. The present inventor has found that a writing tip as disclosed herein provides numerous advantages over known signal transmitting writing tips that are typically constructed from a metal core coated with a polymer material. For example, the present inventor has found that by constructing the writing tip as disclosed herein durability of the writing tip may be improved, user experience with the writing tip may be improved and manufacturing costs may be reduced. In addition, the present inventor has found that a writing tip constructed as disclosed herein is less likely to scratch a touch screen and/or digitizing surface as compared to known writing tips that include a metal core.

According to an aspect of some embodiments of the present invention, there is provided a stylus including a housing, a writing tip at least partially extending out of the housing, the writing tip formed with a compound material including a non-conductive base material and conductive filler, and circuitry electrically connected to the writing tip, the circuitry operative to providing a signal for transmission via the writing tip.

Optionally, the conductive filler includes carbon Nano-tube particles.

Optionally, the compound material is formed by coating the non-conductive base material with the conductive filler.

Optionally, the conductive filler includes at least one of carbon black powder and aluminum powder.

Optionally, the compound material includes adhesive material operative to bind the conductive fillers to the non-conductive base material.

Optionally, the non-conductive base material is at least one of a thermoplastic or a thermoset polymer.

Optionally, the non-conductive base material is synthetic fiber.

Optionally, the writing tip is formed by an injection molding process or compression molding.

Optionally, the writing tip is formed by injection molding process.

Optionally, the writing tip operates as an antenna for wirelessly transmitting the signal.

Optionally, the stylus includes a frame substantially surrounding at least a portion of the writing tip, wherein the frame is formed with conductive material.

Optionally, at least a portion of the housing surrounding the writing tip includes conductive material.

Optionally, the stylus includes an isolating element operative to electrically isolate the writing tip from the conductive material.

Optionally, the writing tip is movable and recedes toward the housing of the stylus in response to contact pressure applied on the writing tip.

Optionally, the writing tip is shaped with one or more bearing elements.

Optionally, the writing tip is formed from two separate parts and wherein one of the parts is formed from the compound material.

According to an aspect of some embodiments of the present invention, there is provided writing pin for use in a signal emitting stylus, wherein the writing pin operates as an antenna for wirelessly transmitting a signal and wherein the writing pin is formed from a compound material including a non-conductive base material combined with conductive particles.

Optionally, the non-conductive base material includes a polymer.

Optionally, the non-conductive base material includes a synthetic fiber.

Optionally, the conductive filler includes carbon Nano-tube particles.

Optionally, the compound material is formed by coating the non-conductive base material with the conductive filler.

Optionally, the conductive filler includes at least one of carbon black powder and aluminum powder.

Optionally, the compound material includes adhesive material operative to bind the conductive fillers to the non-conductive base material.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic drawing of a prior art writing tip constructed with a metal core that is coated with a polymer material;

FIGS. 2A and 2B are perspective and side view, respectively, of an exemplary writing tip, in accordance with some embodiments of the present invention;

FIG. 3 is a simplified schematic drawing of the writing tip fitted into a stylus, in accordance with some embodiments of the present invention;

FIG. 4 is a side view of an exemplary felt writing tip, in accordance with some embodiments of the present invention;

FIGS. 5A and 5B are perspective and front view, respectively, of an exemplary conductive tip holder operative to hold the felt writing tip, in accordance with some embodiments of the present invention;

FIG. 6 is a simplified block diagram of a stylus, in accordance with some embodiments of the present invention;

FIG. 7 is a simplified block diagram of an exemplary digitizer system operable to receive input from a stylus in accordance with some embodiments of the present invention; and

FIG. 8 is a side view of an exemplary writing tip constructed from two different parts, in accordance with some embodiments of the present invention.

### DESCRIPTION OF SPECIFIC EMBODIMENTS OF THE INVENTION

The present invention, in some embodiments thereof, relates to a writing tip for a stylus, and more particularly, but not exclusively to a writing tip from which a signal is transmitted for interacting with a digitizer sensor.

Some known styluses that are operative to emit signals to be picked up by a digitizer sensor, operate to emit the signal via the writing tip so that position of the stylus can be accurately detected by the digitizer sensor. Since the writing tips are used for signal transmission, they are constructed from conductive material, e.g. stainless steel or other non-corrosive metals. Typically, the metal tip is coated or covered with polymer material, e.g. Thermoplastic PolyUrethane (TPU) or PolyOxyMethylene (POM) using injection molding. The polymer coating provides a smoother tip surface that typically provides a better feel for the user when writing with the stylus, and also serves to protect the digitizer sensor and/or touch screen from getting scratched and/or otherwise damaged while a user applies the stylus over the digitizer sensor.

The present inventor has noted that over time the polymer coating tends to wear out to the point at which the metal rod is exposed. Once exposed, the rod is liable to cause damage to the touch screen. Although a thicker coating can be applied to avoid exposure of the metal rod, it is generally desired to limit a diameter of the writing tip for improved user experience when writing with the stylus. The present inventor has also noted that the known writing tips are typically prone to breaking and/or cracking when the stylus falls on the writing tip, and must be replaced.

According to some embodiments of the present invention there is provided a writing tip that overcomes some of the drawback of known writing tips. According to some embodiments of the present invention, a writing tip is constructed from a compound of polymer material and conductive particles. Optionally, TPU, POM, Acrylonitrile Butadiene Styrene (ABS), Poly-Carbonate (PC), Nylon 66 (PA66) or other thermoplastic or thermoset polymers are used to construct the tip. According to some embodiments of the present invention, the conductive particles provide the conductive properties required for transmitting a signal via the writing tip. In some exemplary embodiments, carbon black particles, stainless steel fibers, aluminum powder, and/or carbon fibers are used for the conductive filler. Optionally, the conductive fillers are carbon Nano-tubes, e.g. carbon Nano-tubes manufactured by Nanocyl of Sambreville, Belgium. Optionally, Multi-walled Nano-tubes are used. Typically, particle concentration within the polymer as well as size of the particles is selected based on the required conductive properties for transmitting the signal via the writing tip. According to some embodiments of the present invention, the writing tip is molded into shape using for example injection molding or compression molding.

The present inventor has found that by eliminating the need for the internal metal rod within the writing tip by forming the writing tip from a single compounded material that can be molded in shape, manufacturing cost can be reduced. In addition, the present inventor has found that same or better required properties for signal transmission can be reached when replacing the metal rod with conductive filler. The present inventor has also found that the writing tip formed with a single part is more durable and can also be formed with a smaller diameter tip as compared to known writing tips formed with a coated metal rod or pin.

According to some embodiments of the present invention a writing tip formed with synthetic fibers combined with conductive particles provides a conductive felt tip that is similar in nature to a felt tip used in a traditional felt pens. Optionally, polyester and/or nylon fibers are combined with conductive fibers and/or conductive particles, e.g. carbon black powder, aluminum powder, carbon Nano-tube and pressed together with adhesive material to form a desired shape for the writing tip. Optionally, the adhesive material is used to bind the conductive particles to the fibers. Optionally, the writing tip is coated with or dipped into AQUACYL™, an aqueous dispersion of carbon Nano-tubes available from Nanocyl in Sambreville, Belgium. Optionally, after dipping, the fluid is dried.

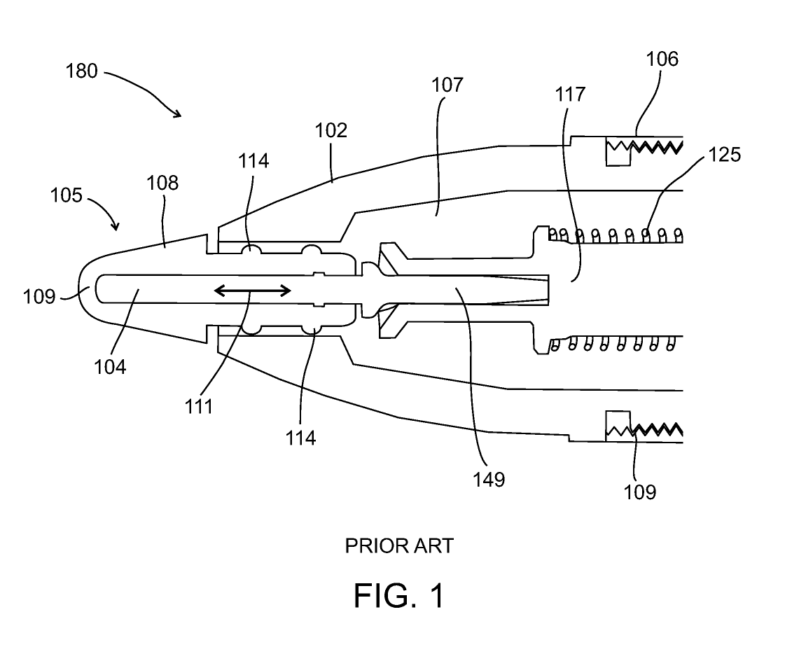

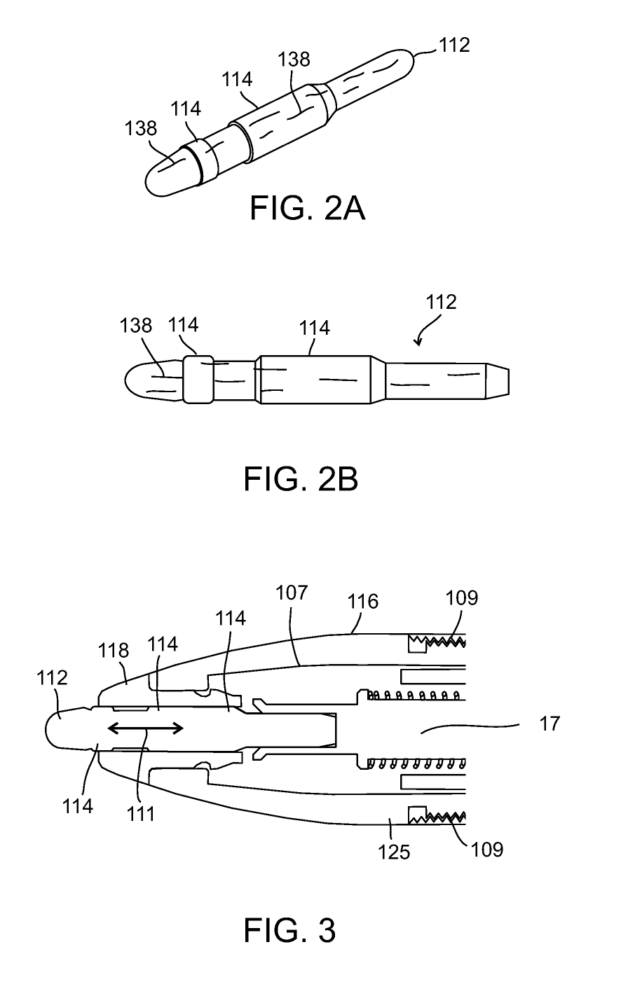

For purposes of better understanding some embodiments of the present invention, as illustrated in FIG. 2-7 of the drawings, reference is first made to the construction and operation of a prior art writing tip for a stylus as illustrated in FIG. 1. In some known styluses 180, a writing tip 105 of the stylus is constructed with a metal core 104, e.g. rod or pin coated with a polymer layer 108. Typically, metal core 104 is exposed at one end 149, distal from an end 109 used for interfacing with a digitizing surface. Typically, metal rod 104 has a length of about 16 mm and a diameter of about 1 mm. Typically, polymer coating 108 has a thickness of about 0.3-0.6 mm. Metal rod 104 together with polymer coating 108 typically provides a writing tip diameter between 1.6-2.2 mm.

Typically, writing tip 105 is inserted through a cavity or hole 107 of frame 102 with exposed end 149 of writing tip 105 fitted into a conductive tip holder 117. Typically conductive tip holder 117 provides a friction fit hold on writing tip 105, and writing tip 105 together with conductive tip holder 117 is free to slide in cavity 107, in a direction indicated by arrow 111. Typically, writing tip 105 includes one or more bearing elements 114 formed with the polymer coating and shaped like rings to assist in smooth motion of writing tip 105.

Typically, a coil spring 125 formed from conductive material is connected to an electric circuit (not shown) for generating a signal to be transmitted via metal rod 104. Coil spring 125 and conductive tip holder 117 operate to transmit the generated signal to metal rod 104. Optionally frame 102 of writing tip 105 and/or a portion of frame 102 is constructed from a conductive material. Typically frame 102 is connected to main housing 106 of stylus 180. Typically, housing 106 houses additional elements of stylus 180, e.g. circuitry and a power source for operating the stylus. Frame 102 and housing 106 are optionally connected by a screw connection 109. Optionally frame 102 and main housing 106 together form the housing of the stylus.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIGS. 2A and 2B showing a perspective and side view, respectively, of an exemplary writing tip, and to FIG. 3 showing a simplified schematic drawing of the exemplary writing tip fitted into a stylus in accordance with some embodiments of the present invention. According to some embodiments of the present invention, writing tip 112 is formed from a compound material including a polymer mixed with a conductive additive 138. According to some embodiments of the present invention, conductive additive 138 provides conductive properties for using tip 112 as an antenna for transmitting a signal, e.g. via wireless communication to a capacitive type digitizer sensor and/or touch screen.

In some exemplary embodiments, one or more of TPU, POM, ABS, PC, Nylon 66 and PA66 is used as the polymer material and one or more of carbon Nano-tubes, carbon black particles, stainless steel fibers, aluminum powder and carbon fibers is used as conductive filler 138. According to some embodiments of the present invention, the concentration of conductive filler 138 is between 0.5% and 20% in weight. Typically, conductivity of the compound depends on the particle concentration as well as the particle injection parameters such as: melt & mold temperature and injection speed. In some embodiments, the resistivity of the compound used for the writing tip is between 50-250,000 ohm/sq for surface resistivity, and between 0.5-2,500 ohm/cm for volume resistivity. According to some embodiments of the present invention, carbon Nano-tubes elements sized between 3-15 Nano (10⁻⁹m) in diameter and 0.1-10 micron (10⁻⁶m) in length are used. Optionally, Multi-walled Nanotubes are used.

According to some embodiments of the present invention, the compound material is molded into the desired shape to form writing tip 112. In some exemplary embodiments, the compound material is shaped with one or more ring bearing elements 114 for easy insertion of writing tip 112 into cavity 102 through a guide 118. Typically, ring bearing elements 114 provide for low friction sliding of writing tip 112 along the length of isolating guide 118, e.g. in a direction indicated by arrow 111. Alternatively, writing tip 112 can be shaped without bearing elements and instead bearing elements can be provided in inner walls of isolating guide 118 as will be discussed further herein. The present inventor has found that by using a compound material that does not require coating, a diameter of the writing tip diameter can be reduced to 1.3 mm or less depending on the properties of the compound material, e.g. hardness of the polymer. Optionally, larger diameters can be used.

According to some embodiments of the present invention, writing tip 112 is inserted into tip holder 107 through guide 118. According to some embodiments of the present invention, guide 118 is constructed from an isolating material, e.g. a polymer, and serves to provide electrical isolation between conductive writing tip 112 and frame 116. Typically, frame 116 substantially surrounds and/or encompasses writing tip 112 is formed from conductive material, e.g. non-corrosive metal and serves as a reference plane and/or a ground. According to some embodiments of the present invention, guide 118 provides a defined distance between writing tip 112 and frame 116 that is required to reduce the mutual capacitance between them, e.g. between about 0.8-1.2 mm. Typically, writing tip 112 receives the signal to be transmitted via conductive tip holder 117, which is in contact with a spring 125 connected on its other end to an electric circuit (not shown).

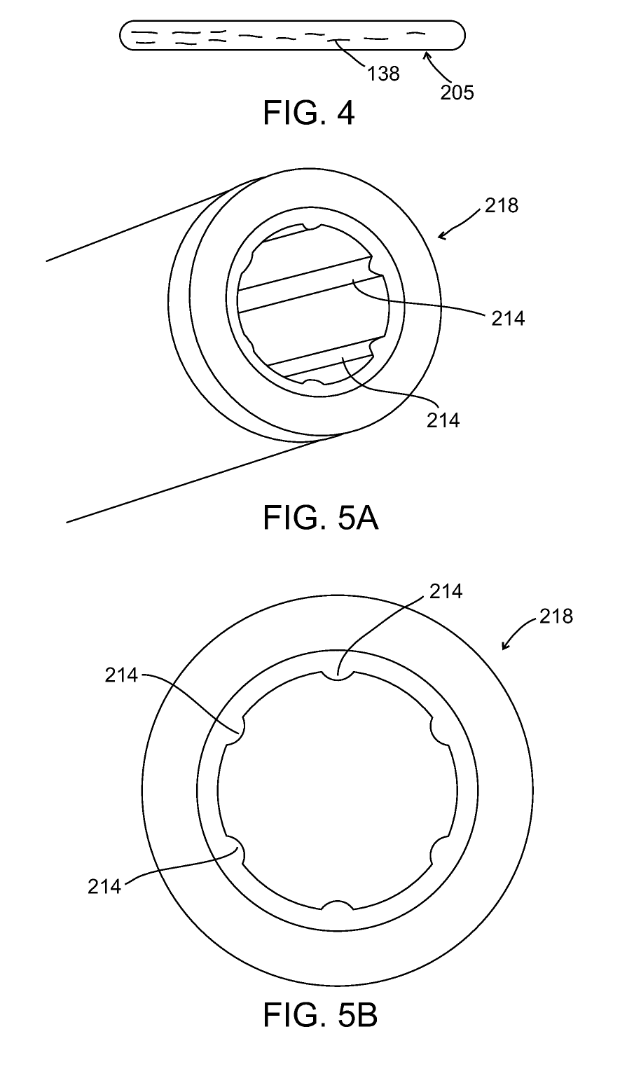

Reference is now made to FIG. 4 showing a side view of an exemplary felt writing tip and to FIGS. 5A and 5B showing a perspective and front view of an exemplary conductive tip holder operative to hold the felt writing tip, in accordance with some embodiments of the present invention. According to some embodiments of the present invention, a writing tip 205 is constructed with synthetic fibers, e.g. polyester or nylon fibers that are mixed with a conductive filler 138, e.g. carbon black powder, aluminum powder and carbon Nano-tube elements. Typically, the synthetic fibers are processed and pressed together with adhesive material to form writing tip 205 that is similar in nature to a felt tip used in a traditional felt pen. Typically the conductive filler is mixed within the fibers to create a conductive felt writing tip. In some exemplary embodiments, an extrusion molding process is used to shape writing tip 205. Optionally, a binder is added to the compound to bind the carbon Nano-tube particles to the synthetic fibers. Size and concentration of the conductive filler may be similar to that described in reference to FIG. 2. In some exemplary embodiments, conductive properties are added to felt writing tip 205 once formed into a desired shape by coating and/or dipping the writing tip into AQUACYL™ which is a fluid comprising carbon Nano-tube particles, and then drying the fluid.

Referring now to FIGS. 5A and 5B, according to some embodiments of the present invention, a guide 218 (similar to guide 118 in FIG. 2) for receiving writing tip 205 into cavity 107 of housing 102 (FIG. 2) is shaped with a plurality of bearing elements 215 in the shape of protrusions that extend along at least part of a length of guide 218. Typically, for writing tips that are shaped without bearing elements 114, a guide 218 can be used instead of guide 118. The present inventor has found that writing tip 205 provides a softer and smoother feel as compared to known writing tips for styluses.

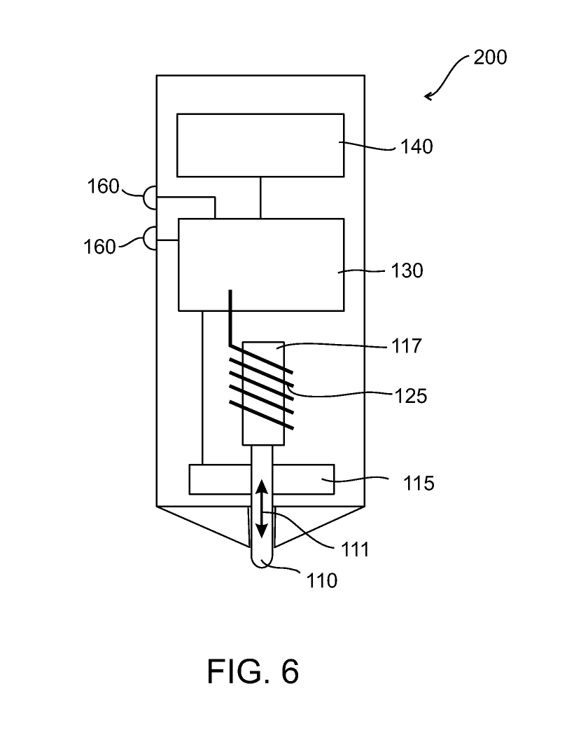

Reference is now made to FIG. 6 showing a simplified block diagram of a stylus, in accordance with some embodiments of the present invention. According to some embodiments of the present invention, a stylus 200 includes a tip 110, a tip holder 117, a spring element 125, circuitry 130, a tip displacement detector 115, one or more operation switches 160, and a power source 140. According to some embodiments of the present invention, circuitry 130 is operable to generate a signal for transmission via writing tip 110. According to some embodiments of the present invention, a signal generated by circuitry is received by writing tip 110 via conductive spring element 125 that is in physical contact with conductive tip holder 117. Optionally, one end of spring element 125 is electrically connected to circuitry 130, e.g. soldered onto a printed circuit board of circuitry 130. According to some embodiments of the present invention, writing tip 110 is operative to be displaced in a direction 111 in response to pressure applied on writing tip 110 as when interfacing a digitizer sensor in pen-down mode. Typically, spring element 125 provides a counter force (and is compressed) in response to pressure applied on the writing tip 110. According to some embodiments of the present invention, tip displacement detector 115 is operable to detect movement of writing tip 110. In some exemplary embodiments, operation of tip displacement detector is controlled by circuitry 130. In some exemplary embodiments, output from tip displacement detector 115 is encoded by controller 115 prior to being transmitted to writing tip 110 for wireless transmission.

Typically, circuitry 130 controls operation of stylus 200 and provides processing and memory capability. Optionally, one or more states of one or more operation switches is encoded and transmitted. Additionally, stylus 200 may comprise, for example, aspects similar to aspects of styluses described in incorporated US Patent Application Publication No. 20080128180.

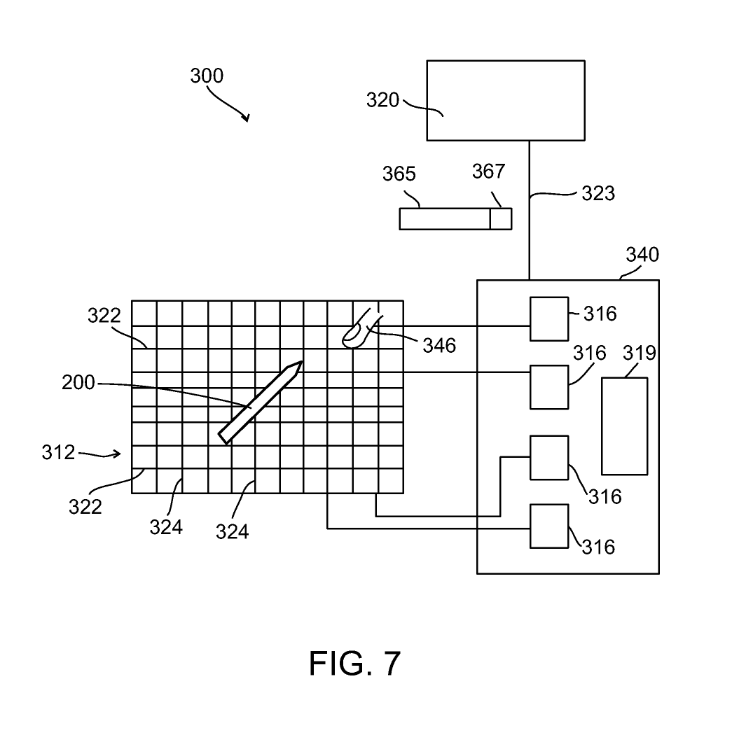

Reference is now made to FIG. 7 showing a simplified block diagram of an exemplary digitizer system operable to receive input from a stylus in accordance with some embodiments of the present invention. The digitizer system 300 may be suitable for any computing device that enables interactions between a user and the device, e.g. mobile computing devices that include, for example, FPD screens. Examples of such devices include Tablet PCs, pen enabled lap-top computers, tabletop computer, PDAs or any hand held devices such as palm pilots and mobile phones.

According to some embodiments of the present invention, digitizer system 300 includes a sensor 312 for sensing output and tracking position of stylus 200 and/or tracking position of user touch, e.g. fingertip touch 346. In some exemplary embodiments sensor 312 includes a patterned arrangement of conductive strips or lines that are optionally arranged in a grid including row conductive strips 322 and column conductive strips 324, also referred to as antennas or conductors. In some exemplary embodiments, sensor 312 is transparent and is optionally overlaid on a Flat Panel Display (FPD). According to some embodiments of the present invention, signal transmitted by stylus 200 is picked up by one or more row conductive strips 322 and column conductive strips 324 of sensor 312. Typically, a signal transmitted by stylus 200 is picked up by conductive strips that are closest to the writing tip of stylus 200, so that position of interaction with the stylus can be detected and tracked by the digitizer sensor based on output from sensor 312. According to some embodiments of the present invention, sensor 312 is a capacitive based sensor that detects, e.g. simultaneous detects a signal transmitted by stylus 200 and the presence of one or more finger touches.

Typically, circuitry for detecting output from sensor 312 is provided on one or more Printed Circuit Boards (PCBs) 340 that are positioned in proximity to sensor 312. One or more Application Specific Integrated Circuit (ASICs) 316 positioned on PCB 340 comprise circuitry to sample and process the output of sensor 312 into a digital representation. Digital output is optionally forwarded to a digital unit 319, e.g. a digital ASIC unit mounted also on PCB 340, for further digital processing. Typically, output from digital unit 319 is forwarded to a host 320 via an interface 323 for processing by the operating system or any current application. According to some embodiments, digital unit 319 also produces and sends a triggering pulse to at least one of the conductive lines, e.g. a trigger pulse with frequency of 10-300 KHz. In some exemplary embodiments, finger touch detection is facilitated when sending a triggering pulse to the conductive lines. In some embodiments, ASICs 316 and digital unit 319 are implemented as a single component.

According to some embodiments of the present invention, digitizer system 300 includes a stylus garage 365 for storing stylus 200 while not being used. Optionally, stylus garage 365 includes a charger 367 for charging a battery or a capacitor of stylus 200. Optionally, stylus 200 is powered with a wire, based in stylus garage 365 or with electrical decoupling. Optionally digitizer 300 includes an excitation coil surrounding sensor 312 for transmitting a triggering signal to stylus 200. Alternatively, triggering signals may be provided by one or more row conductive strips 322 or one or more column conductive strips 324 of sensor 312 and received by stylus 200.

According to some embodiments of the present invention, digital unit 319 determines the tip pressure applied on stylus 200, based on encoded signals transmitted by stylus 200, e.g. analog encoded signals, and received by sensor 312. In some exemplary embodiments of the present invention, hovering of an object, e.g. stylus 200, fingertip 346 and/or hand, is also detected and processed by digital unit 319. According to some embodiments of the present invention, hovering (pen-up) and touching (pen-down) state of a stylus is differentiated by signals transmitted by the stylus, e.g. analog encoded signals. Typically, stylus 200 is operable to be used with a capacitive touch screen. Optionally, stylus 200 can be added as a stand-alone product to an existing capacitive touch screen that includes circuitry that supports stylus interaction.

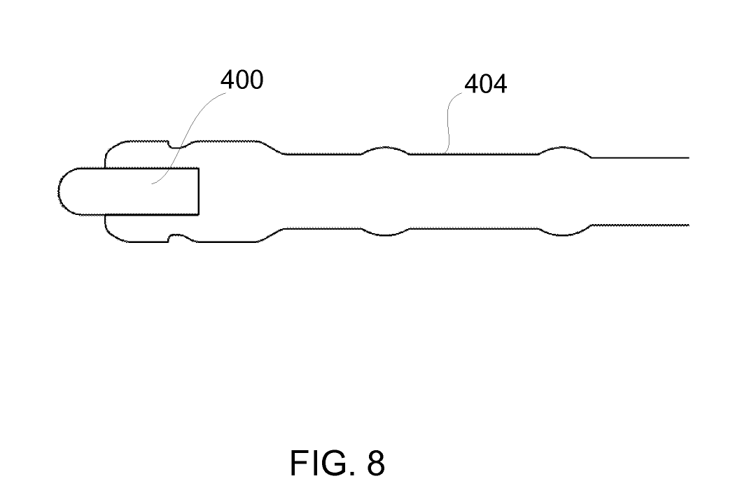

Reference is now made to FIG. 8 showing a side view of an exemplary writing tip that is constructed from two different parts, in accordance with some embodiments of the present invention. According to some embodiments of the present invention, writing tip is constructed from a writing end 400 formed from one material and a main body 404 formed from another material. In some exemplary embodiments, writing end 400 is formed from a material that can provide durability against impact and a good writing feel while main body 404 is formed from a material that can provide low friction as it slides within guide 118 (FIG. 3). In some exemplary embodiments, main body 404 is formed from a conductive material, e.g. metal or a conductive compound as described herein and is used to transmit a signal generated in the stylus. In some exemplary embodiments, writing end 400 is also formed from a conductive material, e.g. a conductive compound as described herein and writing end 404 operates as an antenna for transmitting the generated signals. In other embodiments of the present invention, writing end 400 is formed from an isolating material, e.g. elastomer, plastic or felt material and signals transmitted from the stylus are transmitted directly from main body 404.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A stylus comprising:
a housing;
a writing tip at least partially extending out of the housing, the writing tip formed with a compound material including a non-conductive base material and conductive filler; and
circuitry electrically connected to the writing tip, the circuitry operative to providing a signal for transmission via the writing tip.

2. The stylus of claim 1, wherein the conductive filler includes carbon Nano-tube particles.

3. The stylus of claim 1, wherein the compound material is formed by coating the non-conductive base material with the conductive filler.

4. The stylus of claim 1, wherein the conductive filler includes at least one of carbon black powder and aluminum powder.

5. The stylus of claim 1, wherein the compound material includes adhesive material operative to bind the conductive fillers to the non-conductive base material.

6. The stylus of claim 1, wherein the non-conductive base material is at least one of a thermoplastic or a thermoset polymer.

7. The stylus of claim 1, wherein the non-conductive base material is synthetic fiber.

8. The stylus of claim 1, wherein the writing tip is formed by an injection molding process or compression molding.

9. The stylus of claim 1, wherein the writing tip is formed by injection molding process.

10. The stylus of claim 1, wherein the writing tip operates as an antenna for wirelessly transmitting the signal.

11. The stylus of claim 1, comprising a frame substantially surrounding at least a portion of the writing tip, wherein the frame is formed with conductive material.

12. The stylus of claim 1, wherein at least a portion of the housing surrounding the writing tip includes conductive material.

13. The stylus of claim 12, comprising an isolating element operative to electrically isolate the writing tip from the conductive material.

14. The stylus of claim 1, wherein the writing tip is movable and recedes toward the housing of the stylus in response to contact pressure applied on the writing tip.

15. The stylus of claim 1, wherein the writing tip is shaped with one or more bearing elements.

16. The stylus of claim 1, wherein the writing tip is formed from two separate parts and wherein one of the parts is formed from the compound material.

17. A writing pin for use in a signal emitting stylus, wherein the writing pin operates as an antenna for wirelessly transmitting a signal and wherein the writing pin is formed from a compound material including a non-conductive base material combined with conductive particles.

18. The writing pin of claim 17, wherein the non-conductive base material includes a polymer.

19. The writing pin of claim 17, wherein the non-conductive base material includes a synthetic fiber.

20. The writing pin of claim 17, wherein the conductive filler includes carbon Nano-tube particles.

21. The writing pin of claim 17, wherein the compound material is formed by coating the non-conductive base material with the conductive filler.

22. The writing pin of claim 17, wherein the conductive filler includes at least one of carbon black powder and aluminum powder.

23. The writing pin of claim 17, wherein the compound material includes adhesive material operative to bind the conductive fillers to the non-conductive base material.
